(19) United States
(12) Patent Application Publication
(10) Pub. No.: US 2015/0085117 A1
(43) Pub. Date: Mar. 26, 2015

(54) DRIVING ASSISTANCE APPARATUS

(71) Applicant: CROSS MULTIMEDIA INCORPORATION, New Taipei City (TW)

(72) Inventor: Chih-Tsung CHANG, New Taipei City (TW)

(21) Appl. No.: 14/303,094

(22) Filed: Jun. 12, 2014

(30) Foreign Application Priority Data
Sep. 25, 2013 (TW) 102217924
Apr. 9, 2014 (TW) 103206132

(51) Int. Cl. H04N 7/18; B60R 11/04

(52) U.S. Cl. CPC H04N 7/183; B60R 11/04
USPC 348/148

(57) ABSTRACT

A driving assistance apparatus is provided. The driving assistance apparatus comprises a video capturing apparatus and a display apparatus. The video capturing apparatus comprises an image capturing device and a case. The case is adapted to be disposed in front of a side rear-view mirror of a vehicle and on the body shell of the vehicle. In this way, the lens of the image capturing device is towards the backwards direction of the vehicle. The display apparatus comprises a base and a display device. The base of the display apparatus is disposed inside the vehicle and within a predetermined space defined by the side rear-view mirror. When the driving assistance apparatus is on, the image capturing device continuously captures a plurality of image frames and the display device displays each of the image frames based on the selection display-region.

### CROSS-REFERENCES TO RELATED APPLICATIONS

The present invention claims priority under 35 U.S.C. §119 to Taiwanese Patent Application No. 102217924, filed on Sep. 25, 2013 and Taiwanese Patent Application No. 103206132, filed on Apr. 9, 2014, the entire contents of which is incorporated herein by reference.

### BACKGROUND OF THE INVENTION

1. Field of the Invention

The present invention relates to a driving assistance apparatus. More particularly, the present invention relates to a driving assistance apparatus capable of providing rear-view images.

2. Descriptions of the Related Art

Vehicles have become a very popular means of transportation. However, the increases in number of vehicles have increased the number of traffic accidents. It has been difficult to identify fault in traffic accidents. While driving a vehicle, the driver observes the road conditions at the two sides of and behind the vehicle through using the rear-view mirror disposed inside the vehicle and the side rear-view mirrors disposed at the two sides of the vehicle outside the front window. The driver can check if any vehicle is approaching and to avoid traffic accidents through these mirrors. However, the rear-view mirror and the side rear-view mirrors limit the visibility range depending on the reflection angle, position of the driver seat, height of the driver seat, sitting height of the driver, angle of the mirror, radian of the mirror, or the like. Moreover, when the driver tries to observe the road through the side rear-view mirrors, the person in the shotgun seat usually will block the view of the driver.

Accordingly, it is important in the field to provide a driving assistance apparatus suitable for the driving habits of drivers and capable of providing more driving information.

### SUMMARY OF THE INVENTION

To solve the aforesaid problems, the present invention provides a driving assistance apparatus used with a vehicle. The vehicle defines a forwards direction and a backwards direction and comprises a body shell, a side rear-view mirror, and a driver seat. The side rear-view mirror defines the first visibility range. The driver seat and the side rear-view mirror define the first direction. The first angle is formed between the first direction and facing direction of the driver seat.

The driving assistance apparatus comprises a video capturing apparatus and a display apparatus that is electrically wired or wirelessly connected to the video capturing apparatus. The video capturing apparatus comprises an image capturing device and a case. The case is adapted to be disposed in front of the side rear-view mirror and on the body shell so that the lens of the image capturing device faces towards the back and the image capturing device defines the second visibility range, wherein the second visibility is greater than the first visibility range. The image capturing device continuously captures a plurality of first image frames based on the second visibility range when the driving assistance apparatus is on.

The display apparatus comprises a base and a display device. The base is adapted to be disposed inside the vehicle and within a predetermined space defined by the side rear-view mirror. The driver seat and the display apparatus define a second direction. A second angle is formed between the second direction and the facing direction of the driver seat. The second angle is smaller than the first angle. The display device is configured to display each of the image frames based on the selection display region when the driving assistance apparatus is on, wherein the dimension of the selection display region is smaller than the dimension of each of the image frames.

As can be known from the above descriptions, the video capturing apparatus of the driving assistance apparatus of the present invention is disposed in front of the side rear-view mirror and outside the body shell of the vehicle. The display apparatus thereof is disposed inside the body shell of the vehicle and within the predetermined space defined by the side rear-view mirror. Through the aforesaid arrangement, the second visibility range that is based on a plurality of image frames that are captured by the video capturing apparatus is greater than the first visibility range presented by the side rear-view mirror. Additionally, as compared with observing the side rear-view mirrors, the driver on the driver seat only needs to move his/her head within a smaller range when he/she observes the display apparatus because the second angle is smaller than the first angle. The driver can drive securely with the assistance of the driving assistance apparatus of the present invention because the driving assistance apparatus can provide a relatively large visibility range and the driver can observe the road in the back by moving his/her head only within a relatively small range.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view illustrating the framework of a driving assistance apparatus 1 of a first embodiment;

FIG. 1B is a schematic view of a video capturing apparatus 11;

FIG. 1C is a schematic view of a display apparatus 13;

FIG. 1D is a schematic top view of the driving assistance apparatus 1 used with a vehicle 15;

FIG. 1E is a schematic view of each of the image frames and a partial image frame;

FIG. 2A is a schematic view illustrating the framework of a driving assistance apparatus 2 of a second embodiment;

FIG. 2B is a schematic view of a control apparatus 25 of the second embodiment;

FIG. 2C is a schematic view of each of the image frames and a partial image frame;

FIG. 3 is a schematic view illustrating the framework of a driving assistance apparatus 3 of a third embodiment;

FIG. 4A is a schematic view illustrating the framework of a driving assistance apparatus 4 of a fourth embodiment;

FIG. 4B is a schematic view illustrating the method in which the control circuit 45 calculates the speed of an object;

FIG. 5A is a schematic view illustrating the framework of a driving assistance apparatus 5 of a fifth embodiment;

FIG. 5B is a schematic view of a video capturing apparatus 51;

FIG. 5C is a schematic view of a display apparatus 53; and

FIG. 5D is a schematic top view of the driving assistance apparatus 5 used with the vehicle 15.

### DESCRIPTION OF THE PREFERRED EMBODIMENT

In the following description, the present invention will be explained with reference to embodiments thereof. However, these embodiments of the present invention are not intended to limit the present invention to any environment, applications or implementations described in these embodiments. Therefore, the description of these embodiments is only for the purpose of illustration rather than to limit the present invention. In the following embodiments and attached drawings, elements unrelated to the present invention are omitted from depiction; and dimensional relationships among individual elements in the attached drawings are illustrated only for ease of understanding, but not to limit the actual scale.

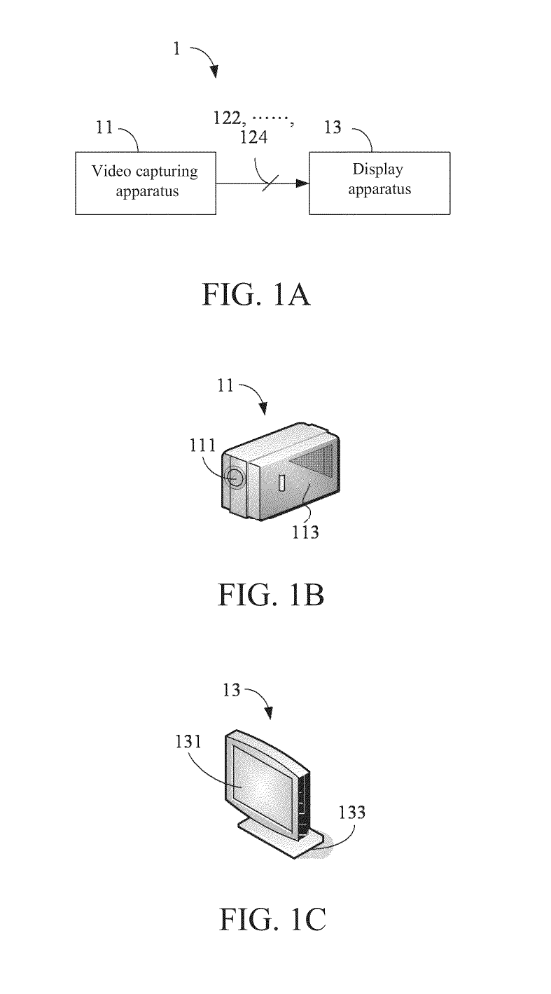

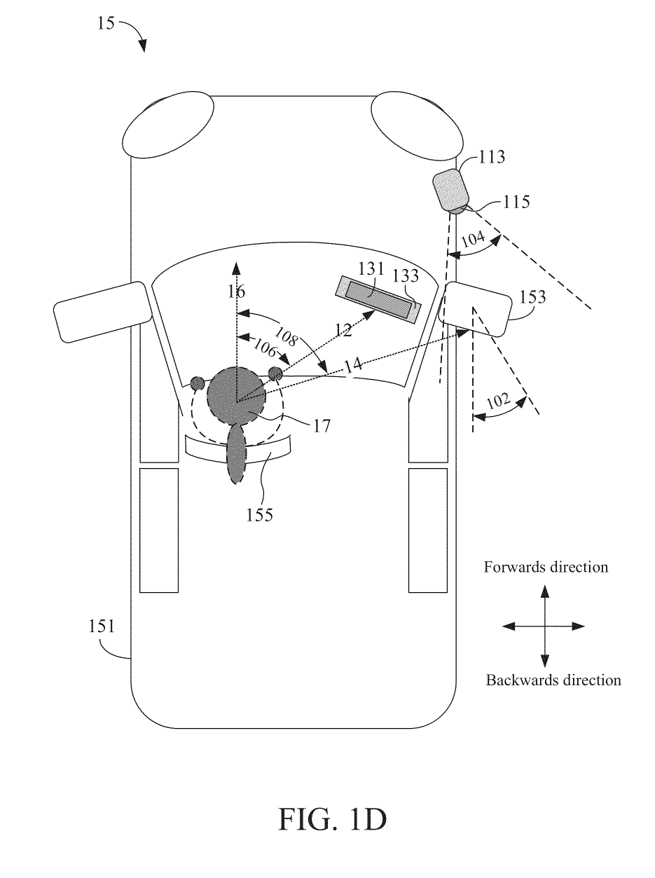

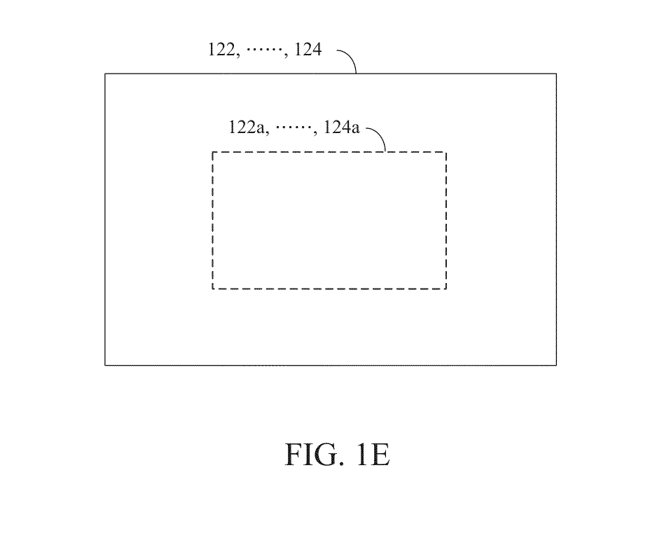

A first embodiment of the present invention is a driving assistance apparatus 1, a schematic view illustrating the framework thereof is depicted in FIG. 1A. The driving assistance apparatus 1 comprises a video capturing apparatus 11 and a display apparatus 13 which are electrically wired or wirelessly connected to each other. The video capturing device 11 comprises an image capturing device 111 and a case 113, as shown in FIG. 1B. The display apparatus 13 comprises a display device 131 and a base 133, as shown in FIG. 1C.

FIG. 1D illustrates a schematic top view of the driving assistance apparatus 1 used with a vehicle 15. The vehicle 15 comprises a body shell 151, a side rear-view mirror 153, and a driver seat 155. It shall be appreciated that the vehicle 15 also comprises other devices, but these devices are unrelated to this embodiment and thus are omitted from depiction. In this embodiment, the side rear-view mirror 153 is disposed near the passenger seat and outside the body shell 151, but the side rear-view mirror may also be disposed near the driver seat 155 and outside the body shell 151 in other implementations. The vehicle 15 defines a forwards and backwards direction. The forwards direction refers to the direction that the driver 17 faces when seated in the driver seat 155, while the backwards direction refers to the direction opposite the forwards direction.

Furthermore, when the driving assistance apparatus 1 is used with a vehicle 15, the case 113 of the video capturing apparatus 11 is disposed in front of the side rear-view mirror 153 and on the body shell 151 (e.g., on the hood of the vehicle 15) so that the lens 115 of the image capturing device 111 faces towards the backwards direction of the vehicle 15. The visibility range 104 is defined, wherein the visibility range 104 is greater than the visibility range 102 provided by the side rear-view mirror 153. The image capturing device 111 continuously captures a plurality of image frames 122, . . . , 124 based on the visibility range 104 via the lens 115 when the driving assistance apparatus 1 is on. Each of the image frames 122, . . . , 124 may be a static image or a frame in a film file.

Moreover, the base 133 of the display apparatus 13 is disposed inside the body shell 151 and within a predetermined space (not shown) defined by the side rear-view mirror 153 (e.g., on the instrument panel or the window of the vehicle 15). The driver seat 155 and the display apparatus 13 define a direction 12. An angle 106 is formed between the direction 12 and the facing direction 16 of the driver seat 155. On the other hand, the driver seat 155 and the side rear-view mirror 153 define a direction 14, and an angle 108 is formed between the direction 14 and the facing direction 16 of the driver seat 155. It shall be appreciated that the angle 106 is smaller than the angle 108. Thus, as compared with observing the side rear-view mirror 153, the driver 17 on the driver seat 155 only needs to move his/her head within a smaller range when he/she observes the display apparatus 13. Furthermore, the person in the shotgun seat is less likely to block the view of the driver 17 when the driver 17 observes the display apparatus 13.

The display device 131 is configured to display partial image frames 122a, . . . , 124a of each of the image frames 122, . . . , 124 based on a selection display region (not shown) when the driving assistance apparatus 1 is on, as shown in FIG. 1E. It shall be appreciated that a dimension of the selection display region is smaller than a dimension of each of the image frames 122, . . . , 124. For example, the selection display region may be 70% of the coverage of each of the image frames 122, . . . , 124 based on the central point of the image frames 122, . . . , 124.

As can be known from the above descriptions, the angle 106 is smaller than the angle 108. Therefore, as compared with observing the side rear-view mirror 153, the driver 17 on the driver seat 155 only needs to move his/her head within a smaller range when he/she observes the display apparatus 13. Moreover, the visibility range 104 that is based on a plurality of image frames 122, . . . , 124 that are captured by the video capturing apparatus 11 is larger than the visibility range 102 presented by the side rear-view mirror 153, so the driver 17 is provided with a larger visibility range. Accordingly, the driver 17 can drive the vehicle 15 securely with the assistance of the driving assistance apparatus 1.

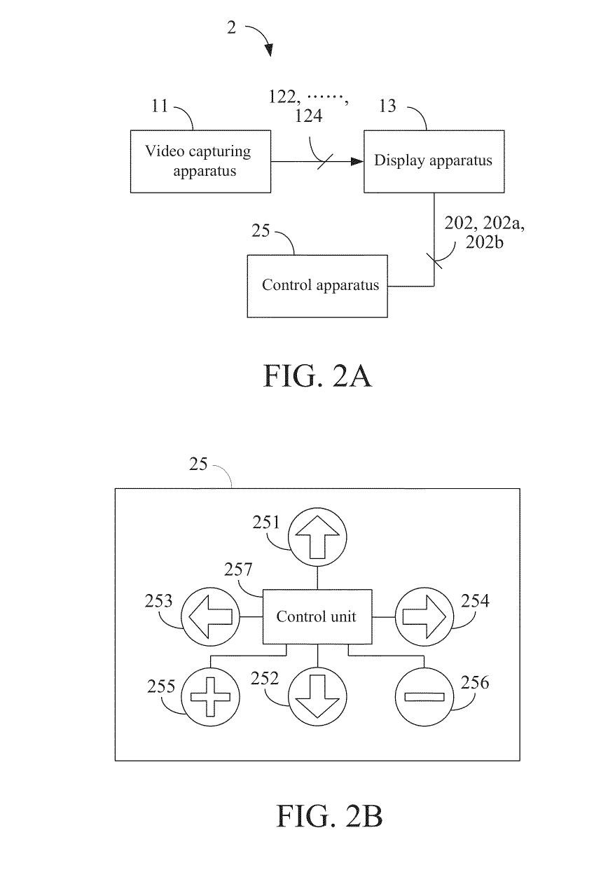

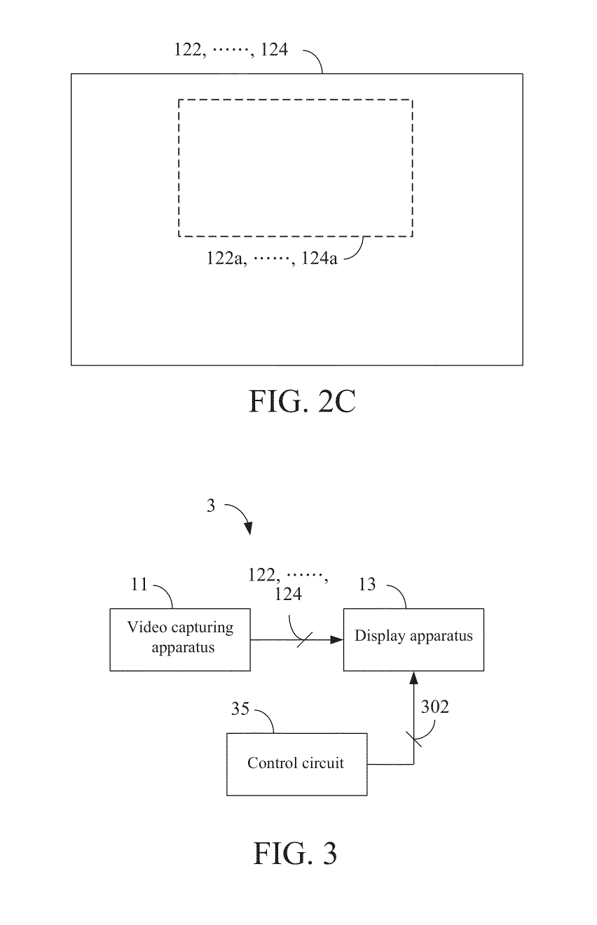

A second embodiment of the present invention is a driving assistance apparatus 2, and a schematic view illustrating the framework thereof is depicted in FIG. 2A. The driving assistance apparatus 2 comprises a video capturing apparatus 11, a display apparatus 13 and a control apparatus 25. The control apparatus 25 is electrically wired or wirelessly connected to the display apparatus 13. In the second embodiment, the video capturing apparatus 11 and the display apparatus 13 can also execute the operations and functions set forth in the first embodiment, and thus will not be further described herein. Only the differences between the second embodiment and the first embodiment will be described in detail hereinafter.

With reference to FIG. 2B, the control apparatus 25 of this embodiment comprises six operating units 251, 252, 253, 254, 255 and 256, and a control unit 257, wherein the operating units 251, 252, 253, 254, 255 and 256 are electrically wire or wirelessly connected to the control unit 257. It shall be appreciated that the number of operating units is not limited in the present invention, so the control apparatus of the driving assistance apparatus in other embodiments may optionally comprise more or fewer operating units. For operational convenience of the driver 17, the control apparatus 25 may be disposed on the base 133 of the display apparatus 13, but is not limited thereto. Furthermore, in other implementations, the control apparatus 25 may also be combined with the display apparatus 13.

In this embodiment, the operating units 251, 252, 253, 254, 255 and 256 are an up key, a down key, a left key, a right key, a zoom-in key, and a zoom-out key respectively. When any one of the operating units 251, 252, 253, 254, 255 and 256 is triggered (e.g., pressed by the driver 17), the control unit 257 will generate a control signal 202 in response to the operating unit that is triggered. The control signal 202 will be transmitted to the display apparatus 13 so that the selection display region is changed by the display device 131 of the display apparatus 13.

For example, if the operating unit 251 (i.e., the up key) is triggered, the control unit 257 will generate a control signal 202a correspondingly. The display device 131 will move the selection display region upwardly in response to the control signal 202a. In other words, partial image frames 122a, . . . , 124a presented by the display device 131 will be as shown in FIG. 2C. As another example, if the operating unit 256 (i.e., the zoom-out key) is triggered, the control unit 257 will generate a control signal 202b correspondingly, and the display device 131 will zoom out the selection display region in response to the control signal 202b.

With the driving assistance apparatus 2 of the second embodiment, the driver 17 can adjust the selection display region, which is set by the display device 131, via the control apparatus 25 depending on his/her figure (e.g., stature), driving habit (e.g., the position of the driver seat 155) and/or driving conditions (e.g., backing up, overtaking, or parking), or the like, so the driver 17 can see different parts of the image frames 122, . . . , 124 in different scales through the display device 131. As a result, the driver 17 can obtain more beneficial information from the driving assistance apparatus 2 to drive the vehicle 15 more securely.

A third embodiment of the present invention is a driving assistance apparatus 3, and a schematic view illustrating the framework thereof is depicted in FIG. 3. The driving assistance apparatus 3 comprises a video capturing apparatus 11, a display apparatus 13 and a control circuit 35. In the third embodiment, the video capturing apparatus 11 and the display apparatus 13 can also execute the operations and functions set forth in the first embodiment, and thus will not be further described herein. Only differences between the third embodiment and the first embodiment will be described in detail hereinafter.

The control circuit 35 is electrically wired or wirelessly connected to a gearshift (not shown) of the vehicle 15 and the display apparatus 13. The control circuit 35 generates a control signal 302 in response to the gearshift that is moved to reverse gear (not shown). The display device 131 of the display apparatus 13 further changes the selection display region in response to the control signal 302. More specifically, the display device 131 of the display apparatus 13 moves the selection display region downwardly and the contents represented by the selection display region are zoomed in.

With the driving assistance apparatus 3 of the third embodiment, the driver 17 can see clearly the space behind and beside the vehicle 15 through the enlarged image displayed on the display device 131 without the help of others when he/she pulls over and/or backs up. Thereby, the possibility of accidental scratches or collisions can be reduced.

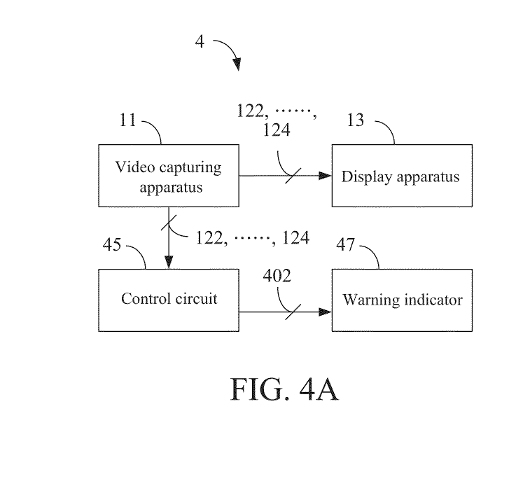

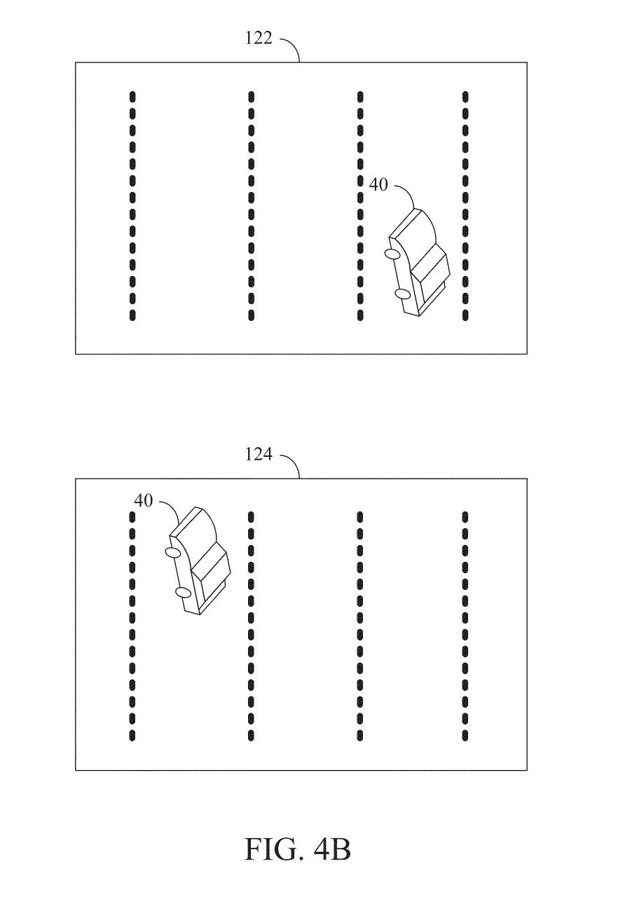

A fourth embodiment of the present invention is a driving assistance apparatus 4, and a schematic view illustrating the framework thereof is depicted in FIG. 4A. The driving assistance apparatus 4 comprises a video capturing apparatus 11, a display apparatus 13, a control circuit 45, and a warning indicator 47. In the fourth embodiment, the video capturing apparatus 11 and the display apparatus 13 can also execute the operations and functions set forth in the first embodiment, and thus will not be further described herein. Only differences between the fourth embodiment and the first embodiment will be described in detail hereinafter.

In this embodiment, the control circuit 45 is electrically wired or wirelessly connected to the video capturing apparatus 11 and the warning indicator 47. The control circuit 45 calculates the speed of an object (not shown) based on at least two of the image frames 122, . . . , 124 captured by the video capturing apparatus 11. For example, the control circuit 45 calculates the speed of an object 40 according to the image frames 122 and 124 by comparing the relative positions of the object 40 in image frames 122 and 124, as shown in FIG. 4B.

If the speed of the object calculated by the control circuit 45 is greater than the threshold (not shown), this means that the object may be approaching the vehicle 15 rapidly. Then, the control circuit 45 generates a control signal 402 correspondingly. A warning signal is generated by the warning indicator 47 after receiving the control signal 402. The form of the warning signal depends on the type of the warning indicator 47. For example, if the warning indicator 47 is a loudspeaker, the warning signal may be a warning sound. As another example, if the warning indicator 47 is a light emitting diode, the warning signal is a blinking light signal.

With the driving assistance apparatus 4 of the fourth embodiment, the control circuit 45 can perceive that an object (e.g., another vehicle) is approaching the vehicle 15 rapidly and inform the driver 17 via the warning indicator 47 so that the driver 17 can respond to an emergency timely to avoid collision with other vehicles.

It shall be appreciated that, as will be understood by those of ordinary skill in the art from the explanation of the first embodiment to the fourth embodiment, the arrangements of the aforesaid embodiments can be arbitrarily integrated in other implementations of the present invention to achieve various different driving assistance effects.

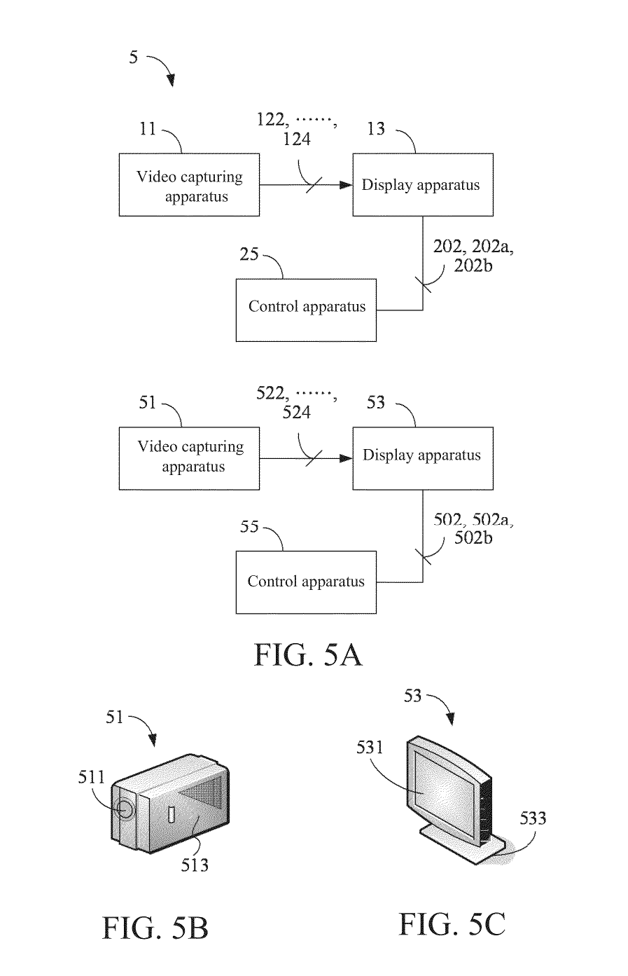

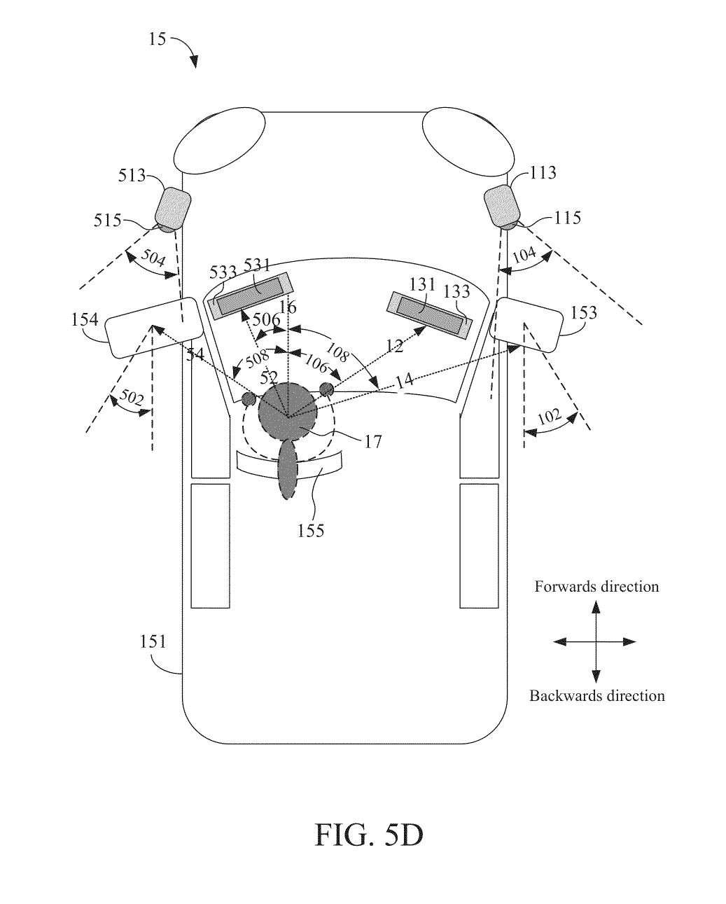

A fifth embodiment of the present invention is a driving assistance apparatus 5, and a schematic view illustrating the framework thereof is depicted in FIG. 5A. The driving assistance apparatus 5 comprises video capturing apparatuses 11 and 51, display apparatuses 13 and 53, and control apparatuses 25 and 55. In the fifth embodiment, the video capturing apparatus 11, the display apparatus 13 and the control apparatus 25 can also execute the operations and functions set forth in the first embodiment and the second embodiment, and thus, will not be further described herein. Only differences between the fifth embodiment and the first embodiment and the second embodiment will be described in detail hereinafter.

The operations and functions of the video capturing apparatus 51, the display apparatus 53 and the control apparatus 55 are substantially the same as those of the video capturing apparatus 11, the display apparatus 13 and the control apparatus 25. Specifically, the display apparatus 53 is electrically wired or wirelessly connected to the video capturing apparatus 51 and the control apparatus 55. Moreover, the video capturing apparatus 51 comprises an image capturing device 511 and a case 513, as shown in FIG. 5B; and the display apparatus 53 comprises a display device 531 and a base 533, as shown in FIG. 5C.

FIG. 5D illustrates a schematic top view of the driving assistance apparatus 5 used with a vehicle 15. The vehicle 15 comprises a body shell 151, side rear-view mirrors 153 and 154, and a driver seat 155. It shall be appreciated that the vehicle 15 also comprises other devices, but these devices are unrelated to this embodiment and thus, are omitted from depiction. In this embodiment, the side rear-view mirror 153 is disposed near the shotgun seat and outside the body shell 151. The side rear-view mirror 154 is disposed near the driver seat and outside the body shell 151. Similarly, the vehicle 15 defines a forwards direction and a backwards direction. The forwards direction refers to the direction that the driver 17 faces when seated in the driver seat 155, while the backwards direction refers to the direction opposite the forwards direction.

When the driving assistance apparatus 5 is used with the vehicle 15, the arrangements, operations, and functions of the video capturing apparatus 11, the display apparatus 13 and the control apparatus 25 are the same as those set forth in the first embodiment and the second embodiment, and thus, will not be further described herein. On the other hand, the case 513 of the video capturing apparatus 51 is disposed in front of the side rear-view mirror 154 and on the body shell 151 (e.g., on the hood of the vehicle 15) so that the lens 515 of the image capturing device 511 faces towards the backwards direction of the vehicle 15. A visibility range 504 is defined, wherein the visibility range 504 is greater than the visibility range 502 provided by the side rear-view mirror 154. The image capturing device 511 continuously captures a plurality of image frames 522, . . . , 524 based on the visibility range 504 via the lens 515 when the driving assistance apparatus 5 is on. Each of the image frames 522, . . . , 524 may be a static image or a frame in a film file.

Moreover, the base 533 of the display apparatus 53 is disposed inside the body shell 151 and within a predetermined space (not shown) defined by the side rear-view mirror 154 (e.g., on the instrument panel or the window of the vehicle 15). The driver seat 155 and the display apparatus 53 define a direction 52. An angle 506 is formed between the direction 52 and the facing direction 16 of the driver seat 155. On the other hand, the driver seat 155 and the side rear-view mirror 154 define a direction 54. An angle 508 is formed between the direction 54 and the facing direction 16 of the driver seat 155. It shall be appreciated that the angle 506 is smaller than the angle 508. Thus, as compared with observing the side rear-view mirror 154, the driver 17 on the driver seat 155 only needs to move his/her head within a smaller range when he/she observes the display apparatus 53.

The display device 531 is configured to display partial image frames of each of the image frames 522, . . . , 524 based on another selection display region (not shown) when the driving assistance apparatus 5 is on. It shall be appreciated that the dimension of the other selection display region is smaller than the dimension of each of the image frames 522, . . . , 524.

Like the control apparatus 25, the control apparatus 55 comprises at least one operating unit (not shown) and a control unit (not shown). The at least one operating unit is electrically wired or wirelessly connected to the control unit. For operational convenience of the driver 17, the control apparatus 55 may be disposed on the base 533 of the display apparatus 53, but is not limited thereto. Furthermore, in other implementations, the control apparatus 55 may also be combined with the display apparatus 53. When any one of the operating units is triggered (e.g., pressed by the driver 17), the control unit will generate a control signal (not shown) in response to the operating unit being triggered. The control signal will be transmitted to the display apparatus 53 so that the display device 531 of the display apparatus 53 changes the selection display region.

As can be known from the above descriptions, the driving assistance apparatus 5 is disposed at the left side and the right side of the vehicle 15. Therefore, the driver 17 can be informed of the road conditions at the two sides of and behind the vehicle by the driving assistance apparatus 5 and adjust the selection display region, which is set by the display devices 131 and 531, via the control apparatuses 25 and 55 depending on practical needs. Thereby, the driver 17 can see different parts of the image frames in different scales on the display devices 131 and 531. As a result, the driver 17 can obtain more beneficial information from the driving assistance apparatus 5 to drive the vehicle 15 more securely.

Furthermore, as can be understood by those of ordinary skill in the art from the explanation of the first embodiment to the fifth embodiment, the arrangements of the aforesaid embodiments can be integrated arbitrarily in other implementations of the present invention to achieve various different driving assistance effects.

The above disclosure is related to the detailed technical contents and inventive features thereof and should not be construed as limited to the embodiments set forth herein. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A driving assistance apparatus, being used with a vehicle, the vehicle defining a forwards direction and a backwards direction, the vehicle comprising a body shell, a first side rear-view mirror, and a driver seat, the first side rear-view mirror defining a first visibility range, the driver seat and the first side rear-view mirror defining a first direction, a first angle being formed between the first direction and a facing direction of the driver seat, the driving assistance apparatus comprising:
a first video capturing apparatus, comprising:
an image capturing device; and
a case, being adapted to be disposed in front of the first side rear-view mirror and on the body shell so that a lens of the image capturing device faces towards the backwards direction and the image capturing device defines a second visibility range, wherein the second visibility is greater than the first visibility range;
wherein the image capturing device continuously captures a plurality of first image frames based on the second visibility range when the driving assistance apparatus is on; and
a first display apparatus, being electrically connected to the first video capturing apparatus and comprising:
a base, being adapted to be disposed inside the vehicle and within a first predetermined space defined by the first side rear-view mirror, the driver seat and the first display apparatus defining a second direction, a second angle being formed between the second direction and the facing direction of the driver seat, the second angle being smaller than the first angle; and
a display device, being configured to display each of the first image frames based on a first selection display region when the driving assistance apparatus is on, wherein a dimension of the first selection display region is smaller than a dimension of each of the first image frames.

2. The driving assistance apparatus of claim 1, further comprising:
a first control apparatus, being electrically connected to the first display apparatus and comprising at least one operating unit and a control unit, wherein the control unit generates a first control signal in response to the at least one operating unit being triggered;
wherein the display device further changes the first selection display region in response to the first control signal.

3. The driving assistance apparatus of claim 2, wherein the at least one operating unit comprises one of an up key, a down key, a left key, a right key, a zoom-in key, a zoom-out key, and a combination thereof.

4. The driving assistance apparatus of claim 1, further comprising:
a control circuit, being electrically connected to a gearshift of the vehicle and the first display apparatus, wherein the control circuit generates a control signal in response to the gearshift being moved to a reverse gear and the display device further changes the first selection display region in response to the control signal.

5. The driving assistance apparatus of claim 1, further comprising:
a control circuit, being electrically connected to the first video capturing apparatus and configured to calculate a speed of an object based on at least two of the first image frames, wherein the control circuit generates a control signal when the speed is greater than a threshold; and
a warning indicator, being electrically connected to the control circuit and configured to generate a warning signal in response to the control signal.

6. The driving assistance apparatus of claim 2, wherein the vehicle further comprises a second side rear-view mirror, the second side rear-view mirror defining a third visibility range, the driver seat and the second side rear-view mirror defining a third direction, a third angle being formed between the third direction and the facing direction of the driver seat, the driving assistance apparatus further comprising:
a second video capturing apparatus, comprising:
an image capturing device; and
a case, being adapted to be disposed in front of the second side rear-view mirror and on the body shell so that a lens of the image capturing device faces toward the backwards direction and the image capturing device defines a fourth visibility range, wherein the fourth visibility range is greater than the third visibility range;
wherein the image capturing device continuously captures a plurality of second image frames based on the fourth visibility range when the driving assistance apparatus is on; and
a second display apparatus, being electrically connected to the second video capturing apparatus and comprising:
a base, being adapted to be disposed inside the vehicle and within a second predetermined space defined by the second side rear-view mirror, the driver seat and the second display apparatus defining a fourth direction, a fourth angle being formed between the fourth direction and the facing direction of the driver seat, the fourth angle being smaller than the third angle; and
a display device, being configured to display each of the second image frames based on a second selection display region when the driving assistance apparatus is on, wherein a dimension of the second selection display region is smaller than a dimension of each of the second image frames.

7. The driving assistance apparatus of claim 6, further comprising:
a second control apparatus, being electrically connected to the second display apparatus and comprising at least one operating unit and a control unit, wherein the control unit of the second control apparatus generates a second control signal in response to the at least one operating unit of the second control apparatus being triggered;
wherein the display device of the second display apparatus further changes the second selection display region in response to the second control signal.
